(19) United States
(12) Patent Application Publication
(10) Pub. No.: US 2017/0164142 A1
(43) Pub. Date: Jun. 8, 2017

(54) A TRUSTED GEOLOCATION BEACON AND A METHOD FOR OPERATING A TRUSTED GEOLOCATION BEACON

(71) Applicant: "BILLENNIUM" SPOLKA Z OGRANICZONA ODPOWIEDZIALNOSCIA, WARSZAWA (PL)

(72) Inventor: JAROGNIEW RYKOWSKI, POZNAN (PL)

(21) Appl. No.: 14/783,087

(22) PCT Filed: Sep. 14, 2014
(86) PCT No.: PCT/EP2015/070907

§ 371 Date: Nov. 13, 2016

(51) Int. Cl. H04W 4/02; H04W 12/04; H04W 12/06; H04L 9/08

(52) U.S. Cl. CPC H04W 4/02; H04L 9/0872; H04W 12/04; H04W 12/06; H04L 2209/80

(57) ABSTRACT

A method for operating a trusted geolocation beacon, the method comprising the steps of: generating (101) a public and private keys pair associated with the beacon; associating a unique identifier with the beacon; transmitting (104) the public key associated with the unique identifier to an external device; cyclically transmitting (201) beacon's identifier as well as its transmitter's signal power (202); transmitting (302) a signal comprising unencrypted, variable data; transmitting (303) a signal comprising encrypted variable data, which (after a decryption) are the same as the unencrypted variable data, the encryption being effected by using the private key associated with the beacon.

### TECHNICAL FIELD

The present invention relates to a geolocation beacon and a method for operating a geolocation beacon. In particular, the present invention relates to a trusted geolocation beacon, operating using a Bluetooth standard 4.0LE (Low Energy), allowing for determining geolocation of persons, animals and inanimate moving objects.

### BACKGROUND OF THE INVENTION

Recording time and place of presence of moving objects (e.g. persons, animals, vehicles, etc.), has a wide practical application, ranging from time-recording systems, tracking systems for domestic and farm animals, as well as tracking of automotive, air and sea fleets.

The recording may comprise the following processes: (a) identification of an object (for example in order to determine authorization level); and (b) monitoring of the identified object (e.g. a location of a given person).

The identification and monitoring systems may both utilize specialized technologies, from the simplest (e.g. identification cards checked on entry into a workplace and exit from a workplace), to more modern systems using radio tags (RFID—Radio Frequency identification) operating using personal devices such as smart cards, smartphones, and up to advanced biometric systems and behavior analyzers. The recorded data can then be processed, e.g. in order to determine total working time during a given month.

Identification systems have been used in the industry for many years. First, these were mostly mechanical solutions, for example a classic door key, which is “associated” with a specific lock. Subsequently, there have been introduced electronic identification systems that use mobile (carried or associated with a physical object) identifiers, for example, RFID tags/NFC identifiers or knowledge of the monitored persons (protection with a password or PIN) or biometric features (fingerprint, retinal scan, facial characteristic features). Such systems involve asking for performing certain actions by a person under identification (e.g. showing an ID, scanning a finger or entering a password). The identification action may also be automated by using long-range RFID tags (microwave)—in this manner there are identified animals, cars on a highway or transport containers.

Tracking systems, the so-called monitoring systems, are most often associated with a set of cameras (of visible or infrared light) and monitors, where an operator may observe image recorded by a camera, image view may be enhanced with a possibility of image processing or analysis, but this is normally limited to types of objects and not a specific object (e.g. detection of children, distinguishing between sitting and standing persons, counting of persons in a room, etc.). It is possible to monitor a particular person, which is frequently realized by recognizing characteristic points of a face. However, this requires good lighting conditions and observation in a right direction (at a particular angle), and in cheaper solutions it is also subject to considerable errors, which in practice may make it impossible to perform secure and reliable verification.

As may be seen, from the aforementioned overview of available technologies, the identification and monitoring systems have certain drawbacks, including the ones listed below.

There are problems with keeping track of highly mobile persons and other tracked objects, in particular over a larger area or in a long term. These problems are present mainly due to cumbersome procedures (e.g. one needs to show a card at the entrance of each room) and the high cost of installation and maintenance of the system (e.g. a need to install cards' readers at each door).

There are also problems with allowing employees more freedom in choosing a work place and work time—in a typical scheme there should be anticipated all possible situations/rules, and compliance with these is to be verified. In such case, one cannot execute any incidental (ad-hoc) activities.

There is a need to protect sensitive data—persons, subject to monitoring, are reluctant to constant tracking and begin to value their privacy, especially when the tracking requires certain manual operations (e.g. showing a card at the door). Currently used monitoring systems do not provide an adequate level of automation and anonymization of tracked objects.

There is also a need to eliminate fraud and circumvention of security measures (e.g. sharing one's card with other persons).

Recently, there is observed an expansion of new technology of marker beacons, using a flooding transmission of Bluetooth LE 4.0. The beacon is an autonomous unit with its own power supply, which broadcasts (without confirmation) small amounts of information. This information may include data from sensors (temperature, pressure, etc.) or data identification and geolocation data (e.g. serial number of the device, its location, orientation in space—rotation, position relative to the Earth's magnetic pole, etc.). The second group of data, in conjunction with an external almanac, may be used to determine exact geolocation based on the location of the beacon (data transmitted by the beacon) and the measured strength of the received radio signal. In telecommunications, particularly in radio, signal strength refers to a magnitude of an electromagnetic field at a reference point that is at a distance from a transmitting antenna. It may also be referred to as received signal level or field strength. Typically, it is expressed in voltage per length or a difference in transmitted signal power and power of signal received by a reference antenna.

Knowing the signal attenuation in a medium (typically air, or when passing through a wall), and given the data on the strength of the signal at the source (received from the beacon data), there may be determined a distance of the receiver from the beacon. If the signal is received from one beacon, the receiver may determine its location with respect to radio coverage circle. If the signals are received from at least three beacons, by means of triangulation there may be determined exact location of the receiver. There are several commercial systems available on the market, including the most popular one—Estimate beacons (Krakow, Poland; New York, USA).

A signal received from a beacon may be used for identification of the beacon's location or the receiver's location. The latter requires signal processing by the receiver or sending information to an external control system.

An indirect identification thus allows determination of a location of the receiver. In case the receiver is a smartphone, a location of its owner may be assumed. This is a cost efficient solution and more convenient for the users at the same time. Nevertheless, the beacons technology needs to be improved in order to meet security and anonymity requirements. In particular, there must be an additional mechanism provided to ensure that just received signal comes from a real beacon, not a fake transmitter. Moreover, one must be able to prove, after some time, that a real signal has been received and the receiver was temporary placed near a given beacon, thus proving the location.

A US patent application US20150088452 discloses a system for locating and tracking an object, the system comprising; a measuring device configured to determine a property of a paving-related material; a locating device configured to determine a location of the measuring device; a tracking module configured to track the measuring device; and a communications module that transmits tracking information to a remote device. Referring to FIG. 2A of US20150088452, measuring/locating/tracking device 200 may be configured to be in communication with a beacon device, wherein the beacon device may be configured to transmit a signal to measuring/locating/tracking device 200 if it is determined that the device is lost, misplaced, or stolen. In response to receiving the signal, measuring/locating/tracking device 200 can send a signal back to the beacon device indicative of the physical position and/or movement parameters of the unit, as determined by the locating component of measuring/locating/tracking device 200. Its disadvantage is a requirement for bidirectional communication with the beacon. Further, it only generically discloses secure communication.

A US patent application US20110087887 discloses methods and apparatus for providing proof of multiple entities being co-located at a specific time and location. An attester transmits an attestation message via short range communication; the attestation message includes a time stamp, a location stamp, and a verifiable digital signature. An attestee that stores the attestation message can produce the attestation message at a later time to any interested party, as a proof of co-location with the attester at the specified time and location. In one exemplary embodiment, the methods and apparatus are substantially “open” for public implementation. Such public implementation enables attesters and attestees without prior affiliation, to provide attestation. Furthermore, the device-agnostic methods and apparatus can provide attestation capabilities even in previously deployed systems and devices. Its disadvantages are similar to that described with respect to US20150088452.

There is therefore a need to provide an improved geolocation beacon and a method for operating a geolocation beacon, in particular addressing security and anonymity issues as well as using only unidirectional communication from the beacon to external receivers.

### SUMMARY AND OBJECTS OF THE INVENTION

An object of the present invention is a method for operating a trusted geolocation beacon, the method comprising the steps of: generating a public and private keys pair associated with the beacon; associating a unique identifier with the beacon; transmitting the public key associated with the unique identifier to an external device; cyclically transmitting beacon's identifier as well as its transmitter's signal power; transmitting a signal comprising unencrypted, variable data; transmitting a signal comprising encrypted variable data, which are the same as the unencrypted variable data, the encryption being effected by using the private key associated with the beacon.

Preferably, the encrypted and unencrypted data cyclically transmitted by the beacon are transmitted separately at different time instants or they form a single transmission packet divided into encrypted and unencrypted part.

Preferably, the encrypted variable data are encrypted with a private key assigned to the beacon and stored in the beacon at a time of installation.

Preferably, the variable data comprise variables for which encryption result is different for any subsequent encryption operations.

Preferably, the external device comprises a database indexed with a serial number or an address of the beacon.

An object of the present invention is also a method for determining a trusted geolocation using a signal obtained from the beacon operating according to the present invention, the method comprising the steps of: obtaining the beacon's public key, from an external database, based on the beacon's identifier; using this public key in order to decrypt the encrypted part of the received broadcast; verifying whether the encrypted data and the unencrypted data match; in case of a match, treating the beacon as a trusted beacon and determining a distance of the receiver from the beacon and reporting its location to a database.

Another object of the present invention is a trusted geolocation beacon, the beacon comprising: a data bus communicatively coupled to a memory and other components of the system so that they may be managed by a controller; a geolocation sensor; the beacon further comprising: a public key register storing beacon's public key; a private key register storing beacon's private key; wherein the controller is configured to execute all steps of the method according to the present invention.

Another object of the present invention is a trusted geolocation system comprising: at least one trusted geolocation beacon according to the present invention; at least one client device operating according to the present invention; a server comprising a database storing (a) public keys of registered beacons together with the geolocations of the at least one trusted geolocation beacon; (b) time instants at which a given client device changed location.

### BRIEF DESCRIPTION OF THE DRAWINGS

The objects of the invention presented herein are accomplished by providing a geolocation beacon and method for operating a geolocation beacon. Further details and features of the present invention, its nature and various advantages will become more apparent from the following detailed description of the preferred embodiments shown in a drawing, in which:

FIG. 1 presents a process of beacon's configuration;

FIG. 2 presents a process of use of a beacon in a non-trusted mode;

FIG. 3 presents operation of a beacon in a trusted mode;

FIG. 4 shows an exemplary data structure provided by means of a broadcast signal of a beacon;

FIG. 5 shows a second embodiment of a data structure provided by means of a broadcast signal of a beacon; and

FIG. 6 presents a diagram of the beacon's system according to the present invention.

### NOTATION AND NOMENCLATURE

Some portions of the detailed description which follows are presented in terms of data processing procedures, steps or other symbolic representations of operations on data bits that can be performed on computer memory. Therefore, a computer executes such logical steps thus requiring physical manipulations of physical quantities.

Usually, these quantities take the form of electrical or magnetic signals capable of being stored, transferred, combined, compared, and otherwise manipulated in a computer system. For reasons of common usage, these signals are referred to as bits, packets, messages, values, elements, symbols, characters, terms, numbers, or the like.

Additionally, all of these and similar terms are to be associated with the appropriate physical quantities and are merely convenient labels applied to these quantities. Terms such as “processing” or “creating” or “transferring” or “executing” or “determining” or “detecting” or “obtaining” or “selecting” or “calculating” or “generating” or the like, refer to the action and processes of a computer system that manipulates and transforms data represented as physical (electronic) quantities within the computer's registers and memories into other data similarly represented as physical quantities within the memories or registers or other such information storage.

A computer-readable (storage) medium, such as referred to herein, typically may be non-transitory and/or comprise a non-transitory device. In this context, a non-transitory storage medium may include a device that may be tangible, meaning that the device has a concrete physical form, although the device may change its physical state. Thus, for example, non-transitory refers to a device remaining tangible despite a change in state.

As utilized herein, the term “example” means serving as a non-limiting example, instance, or illustration. As utilized herein, the terms “for example” and “e.g.” introduce a list of one or more non-limiting examples, instances, or illustrations.

### DETAILED DESCRIPTION

An object of the present invention is an improvement to Bluetooth LE 4.0 beacons with an ability to sign transmission with Public Key Infrastructure (PKI) and e-signature for devices authentication.

Some data, transmitted by a given beacon, are encrypted with a private key assigned to the given beacon at a time of installation. These data may be decrypted with the given beacon's public key obtained from an external identification system. A public key is provided by the beacon at request, in particular, at a time of installation. The data comprise variables (such as time or random number), for which encryption result is different for any subsequent encryption operations.

By decrypting and comparing such data with an unencrypted copy transmitted by the same beacon, one may prove that the beacon is a trusted element of the system and nothing simulates its behavior (for example by means of a software application executed on a smartphone).

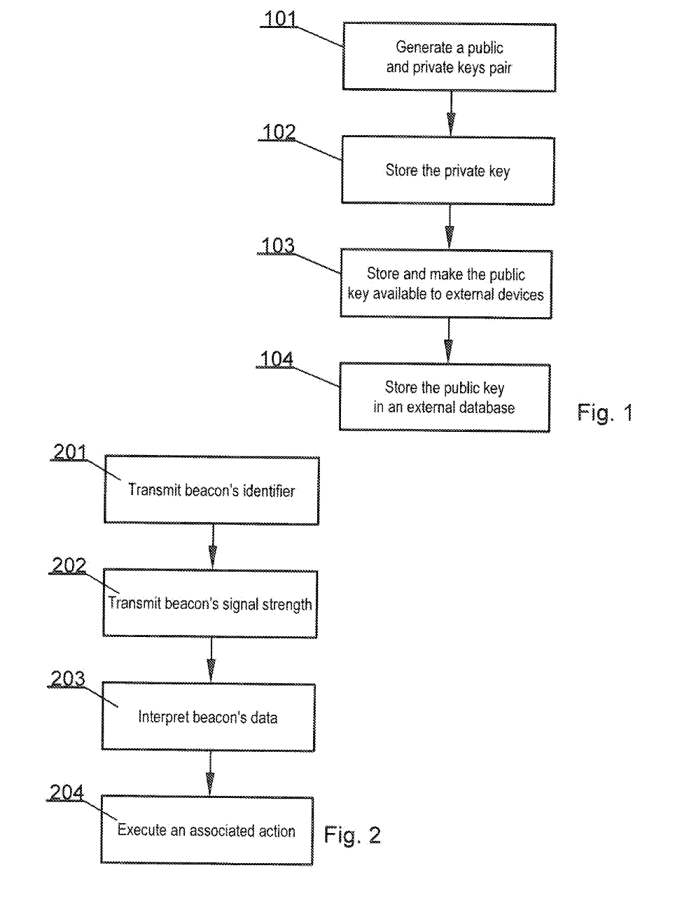

A process of installation and use of the beacon may be split into two stages. During the first stage the beacon is configured. The process of beacon's configuration has been shown in FIG. 1. First, at step (101), there is generated a pair of public and private keys. To achieve this goal, a standard Public Key Infrastructure PKI (Public Key Infrastructure) is applied.

As the encryption scheme, a standard RSA (Rivest-Shamir-Adleman) algorithm or similar may be used, or one of its successors, such as DSA (Digital Signature Algoritm) in case of higher security requirements.

The private key is stored in the beacon (102) and is never made available to any external device. The public key is stored and may be provided, at step (103), to external devices by means of a one-time transmission or a broadcast transmission. Optionally, the public key provided by one time transmission, may be stored (104) in an external almanac (a database) preferably indexed with a serial number (or an address, or other unique identifier) of the beacon.

In the latter case, the public key may by encrypted as a part of an electronic certificate (using local or public Certificate Authority of PKI), thus making it impossible to manipulate the list of the beacons by a third party. In such case, adding and removing the beacons is under selective control of the system, thus the whole set of known beacons may be trusted. Moreover, it is not needed to broadcast the public key by the beacon—based on standard messages (which include serial number of the beacon) it is possible to retrieve the public key from the system at any time.

During the second stage, the beacon is used for geolocation. This may be implemented as a two-part process. FIG. 2 presents a process of use of a beacon in a non-trusted mode.

The beacon cyclically transmits (201) its identifier (preferably the identifier is unique globally or within a certain set of devices, e.g. manufactured by a single company) as welt as its signal power (202). These data may, after interpretation (203) (i.e. supplementing with geolocation data read from an external database using the beacon's identifier) be used to initiate a given action (204), related to location of the receiver of the signal.

As may be seen, there are not any mechanisms verifying a right of the beacon to transmit a signal based on the beacon's identifier. Therefore, such transmission has to be considered non-trusted. Any device comprising a transmitter (e.g. Bluetooth-based) may send such a signal at any other location, which means that such fraud attempts may not be detected and may not be prevented.

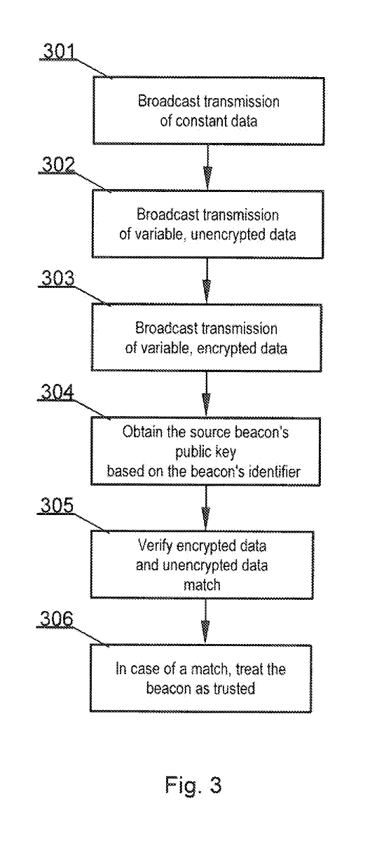

FIG. 3 presents operation of a beacon in a trusted mode. This mode enhances the previous, non-trusted mode with a verification of the sender of the signal. First the beacon transmits (301) a signal comprising constant data (as in step 202). Further, the beacon transmits (302) a signal comprising unencrypted, variable data (preferably time variable data), for example a time counter or successive transmission number. Further, the beacon transmits (303) a signal comprising encrypted, variable data, which are the same as in step (302). The encryption is effected by means of the private key associated with the beacon, according to the rules of RSA algorithm and PKI schema, as mentioned earlier with reference to steps (102-104).

It will be clear, to a skilled person, that data transmitted at step (301) to (303) may be transmitted separately at different time instants or they may form a single transmission packet.

A receiver will obtain (304) the source beacon's public key, from an external database, based on the beacon's identifier (such as a serial number) and uses this key in order to decrypt the encrypted part of the received broadcast. Subsequently, there is verified whether encrypted data and unencrypted data match (305). In case of a match (306), the beacon is treated as a trusted beacon. In case the beacon is not found as trusted, the receiver preferably discards the communication received from that source.

When the beacon is determined as trusted the receiver may determine a distance of the receiver from the beacon and report its location to a database. The reporting may include identification of a time instant at which the beacon's signal was received.

The same authentication method may be applied to a smartphone, registering its public key in an external system, and to any given external system (for example a database of beacons' public keys). As a result, all devices communicating within the system may be considered as trusted, which eliminates fraud. At the same time the main object of the invention is achieved, which is the geolocation of a receiver registering a beacon's signal.

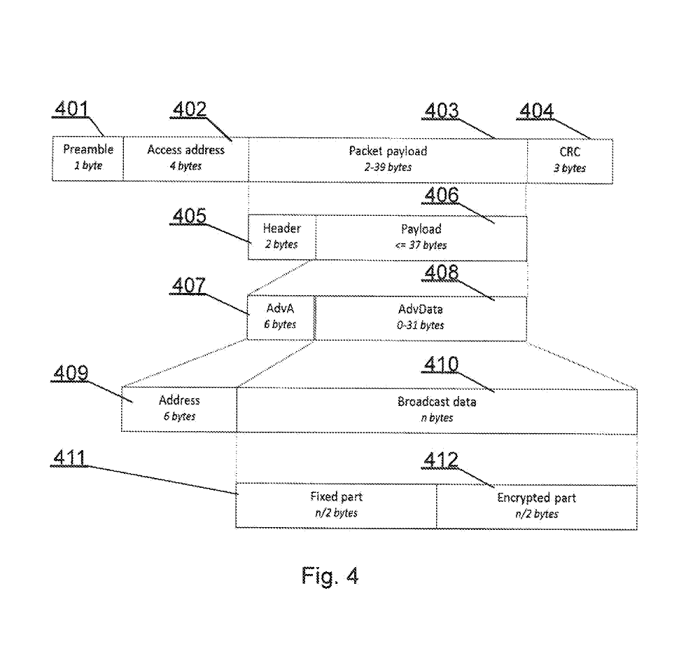

FIG. 4 shows an exemplary data structure provided by means of a broadcast signal of a beacon. Preferably this data structure is a single communication message. It has been assumed that a typical beacon does not use the full length of the payload (403) for broadcast purpose (typically, due to energy efficiency, only few bytes are used). The typically unused part is used in the solution to broadcast the encrypted part of the message. The encrypted part (412), for example half of the broadcast data (410), comprises encrypted copy of unencrypted data present in the first part (411) of the payload.

The other parts are used as follows—a preamble (401) is applied to mark the beginning of a message, an address part (409) is used to broadcast the identifier (unique address) of the beacon, a CRC (Cyclic Redundancy Check) checksum (404) ensures the correctness of the whole message, and a header (405) is used to transmit the used length of the payload part (406). An access address part (402) may be used to broadcast the address of the possible receiver (or receiver group), however, this element is hardly applied for any beacon application.

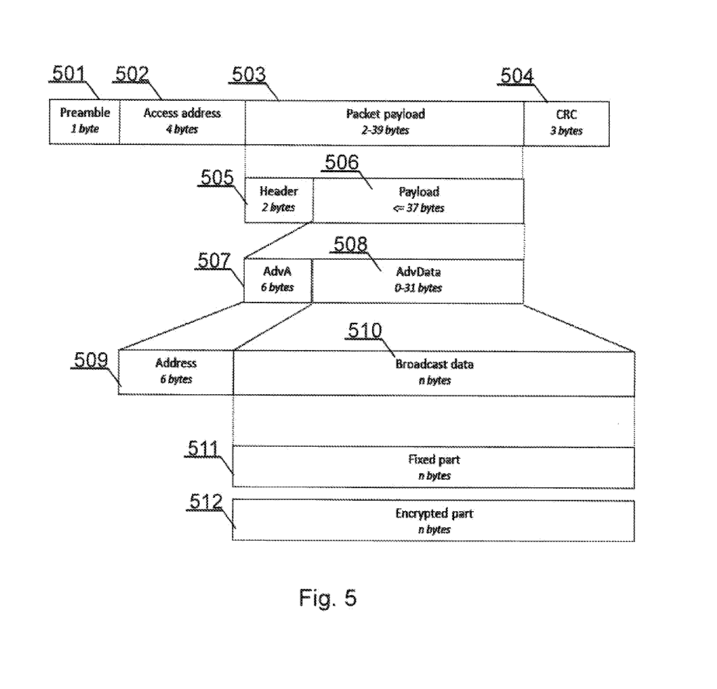

FIG. 5 shows a second embodiment of a data structure provided by means of a broadcast signal of a beacon. This embodiment comprises two subsequent messages: “even” and “odd”. The “even” message comprise unencrypted data while the subsequent “odd” message comprises the same data payload as the “even” message but in an encrypted form (encrypted using the beacon's private key). All the message parts are applied similarly as in the aforementioned case of FIG. 4, such as: (501) for a preamble marking the beginning of a message, (502) for a receiver's address (typically not used), (504) for a CRC check, and (503) for a payload (506), further interpreted as a header marking data length (505), beacon identifier (507, 509), and broadcast information (508, 510).

For “even” messages, the data is transmitted in an unencrypted, traditional form (511), while for “odd” messages—in an PKI-based encrypted form (512). The method of verifying whether the broadcasting beacon is trusted, is the same as in the preceding example, except one must listen to and compare two subsequent messages in order to verify the trust.

It must be noted, that both presented embodiments allow for keeping backwards compatibility and use of trusted transmission also by receivers that are not configured to execute the determination of the level of trust.

The following section of the specification presents several examples of putting the invention into practice. The first example relates to tracking work location and work time off employees.

The system comprises (a) a database of employees tracking data; (b) a local Wi-Fi network; (c) a plurality of geolocation beacons, preferably operating using Bluetooth LE 4.0.

The database stores (a) public keys of registered beacons, indexed with their addresses, together with the beacons' exact geolocations (using for example geo-spatial locations or unique room names); (b) public keys of registered client devices (e.g. a smartphone, a laptop; a smart watch, etc.) together with optional data of their owners; (c) time instants at which a given receiver changed location (it may be inferred that its owner changed location).

Each employee is obliged to carry a registered client device having a geolocation application installed. During installation of this application a private and public key have been generated whereas the public key is stored in the aforementioned database.

A client device receives signals from focal beacons, preferably by means of a Bluetooth LE 4.0 transmission, as well as verifies the level of trust with respect to the different geolocation beacons, by decrypting the received transmission using beacons public keys obtained from a central database. Periodically, e.g. every minute, the application of the client device transmits to the database all the beacons' identifiers determined from the received transmissions from these beacons. This allows the database server to determine (by a triangulation taking into account signal strength method) a geolocation of the client device as well as storage of this geolocation as part of client's record.

Optionally, at any critical status change (e.g. a movement from one location to another in a building) the application may request an associated employee to enter additional data (e.g. a purpose of entrance), which may also be stored in the database.

Data gathered and stored in the database may be browsed and analyzed with further software. Data may also be processed in real time, thereby detecting for example unauthorized persons entering given location(s) or detecting critical conditions such as number of persons at one location (such as an elevator, stairway). Detection of critical conditions may result in executing certain actions such as increasing airflow in a room or preventing opening of windows or preventing closure of doors.

The second example of putting the invention into practice relates to personnel geolocation in a hospital. The method of use of beacons as well as the system are similar as in example one. However, the aim of the system is to quickly locate a nearest medical doctor or specialized equipment in case of sudden critical condition of a patient. Patient's application may also monitor life conditions and/or be equipped with a “panic” button. In case of any of the monitored conditions changes to critical, the client device, running a specialized application, informs an external server about its location and the database application compares the given location to then current locations of doctors and relevant equipment in order to notify specific doctors regarding the patient and location of the equipment. Further, the quickest route to the patient may be presented to the doctor or other personnel.

The third example of putting the invention into practice relates to an intelligent museum guide. In this case the client device's application is also a ticket assigned with an end location. The route between the current location and the end location allows for contextual, interactive navigation among museum's exhibits. Further, a fee for visiting different exhibits may differ depending on the number and type of visited exhibits. This may be visualized by the client device's software application. Similarly, fees for city transport tickets may be determined based on exact routes taken.

The fourth example of putting the invention into practice relates to domestic animals tracking. Tracking of this type has to be fully automatic. Therefore, the beacons must communicate with a receiver while the client device repeatedly reports geolocation. There may be distinguished two cases: (a) a beacon is carried by an animal and receivers are located at key locations in a given area; or (b) an animal carries a receiver/communicator whereas the beacons are located at key locations in a given area.

Due to energy use efficiency, the first case is more convenient as it does not require frequent recharging of battery of the carried device (the receivers are stationary and may be supplied with power from the mains). Each approach of the beacon, carried by the animal, to any of the receivers will result in a verification and in turn a possible alarm and a need for a reaction from the owner. At the same time, when another animal or another beacon is present within the monitored area—after a verification of data encrypted with a public key, such devices may be detected and disregarded.

The fifth example of putting the invention into practice relates to vehicles tracking as well as tracking free parking spaces. In this case, inanimate objects are subjected to tracking. A vehicle comprises a receiver while beacons indicate particular parking spaces and cooperate with an external database in order to indicate the state of parking spaces (e.g. free, occupied, current fee, reservation). A vehicle parking at a given parking space enters the area of signal coverage of a given beacon. Settlement fees may be counted on a per second basis, because one may monitor the beginning and end of cross ‘visibility’ of the beacon and the receiver.

At the same time, since all the system components are trusted, one may immediately make a payment (also in a pico-payment mode, e.g. for every second of staying on car parking). There may also be quickly determined a location of the vehicle based on its identifier (the owner will not have any problems with finding his car) and immediately detect and report certain undesirable situations (unpaid parking space, prolonged stay, long driving around the parking lot and frequent change of place, etc.).

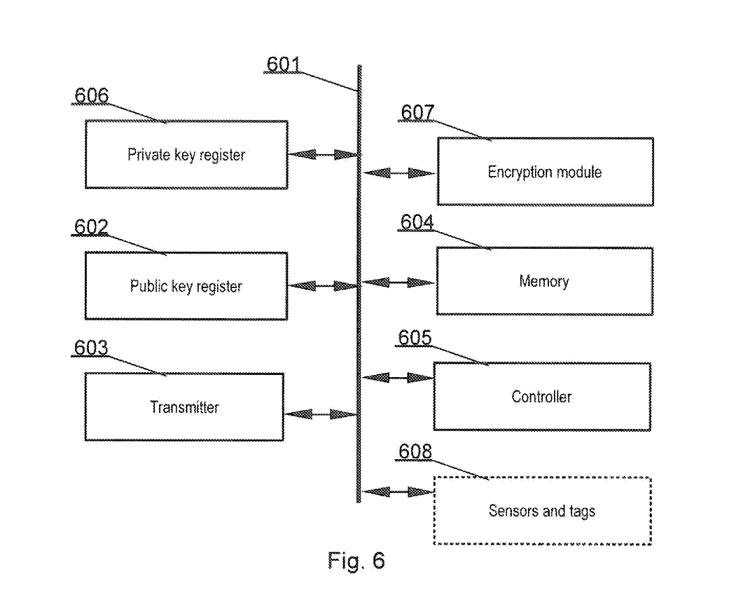

FIG. 6 presents a diagram of the beacon's system according to the present invention. The system creates a beacon device and may be realized using dedicated components or custom made FPGA or ASIC circuits. The system comprises a data bus (601) communicatively coupled to a memory (604). Additionally, other components of the system are communicatively coupled to the system bus (601) so that they may be managed by a controller (605).

The memory (604) may store computer program or programs executed by the controller (605) in order to execute steps of the method according to the present invention. Further the memory may store the unique identifier of the device (beacon) as well as any temporary data processing results such as state of a counter or a timer or data sequence to be transmitted via a transmitter (603).

The system further comprises a public key register (602) and a private key register (606). The public key read from the public key register is used during data encryption by an encryption module (607).

Optionally, the beacon may comprise at least one sensor (608) such as a geolocation sensor, temperature sensor, humidity sensor, proximity sensor etc. Readings from these sensors may also be part of messages transmitted via the transmitter (603).

The beacon according to the present invention allows for efficient and secure tracking of object's geolocation. Therefore, the invention provides a useful, concrete and tangible result.

The present invention presents a method of operation as well as a beacon device, a client device and a complete system for geolocation and tracking of objects. Thus, the machine or transformation test is fulfilled and that the idea is not abstract.

It can be easily recognized, by one skilled in the art, that the aforementioned method for operating a geolocation beacon may be performed and/or controlled by one or more computer programs. Such computer programs are typically executed by utilizing the computing resources in a computing device. Applications are stored on a non-transitory medium. An example of a non-transitory medium is a non-volatile memory, for example a flash memory while an example of a volatile memory is RAM. The computer instructions are executed by a processor. These memories are exemplary recording media for storing computer programs comprising computer-executable instructions performing all the steps of the computer-implemented method according the technical concept presented herein.

While the invention presented herein has been showed, described, and has been defined with reference to particular preferred embodiments, such references and examples of implementation in the foregoing specification do not imply any limitation on the invention. It will, however, be evident that various modifications and changes may be made thereto without departing from the broader scope of the technical concept. The presented preferred embodiments are exemplary only, and are not exhaustive of the scope of the technical concept presented herein.

Accordingly, the scope of protection is not limited to the preferred embodiments described in the specification, but is only limited by the claims that follow.

1. A method for operating a trusted geolocation beacon, the method comprising the steps of:
generating a public and private keys pair associated with the beacon;
associating a unique identifier with the beacon;
transmitting the public key associated with the unique identifier to an external device;
cyclically transmitting beacon's identifier as well as its transmitter's signal power;
transmitting a signal comprising unencrypted, variable data;
transmitting a signal comprising encrypted variable data, which are the same as the unencrypted variable data, the encryption being effected by using the private key associated with the beacon.

2. The method according to claim 1, wherein the encrypted and unencrypted data cyclically transmitted by the beacon are transmitted separately at different time instants or they form a single transmission packet divided into encrypted and unencrypted part.

3. The method according to claim 1, wherein the encrypted variable data are encrypted with a private key assigned to the beacon and stored in the beacon at a time of installation.

4. The method according to claim 1, wherein the variable data comprise variables for which encryption result is different for any subsequent encryption operations.

5. The method according to claim 1, wherein the external device comprises a database indexed with a serial number or an address of the beacon.

6. A method for determining a trusted geolocation of a beacon, comprising the steps of:
obtaining a signal from the beacon by:
generating a public and private keys pair associated with the beacon;
associating a unique identifier with the beacon;
transmitting the public key associated with the unique identifier to an external device;
cyclically transmitting beacon's identifier as well as its transmitters signal power;
transmitting a signal comprising unencrypted, variable data;
transmitting a signal comprising encrypted variable data, which are the same as the unencrypted variable data, the encryption being effected by using the private key associated with the beacon;
obtaining the beacon's public key, from an external database, based on the beacon's identifier;
using this public key in order to decrypt the encrypted part of the received broadcast;
verifying whether the encrypted data and the unencrypted data match;
in case of a match, treating the beacon as a trusted beacon and determining a distance of the receiver from the beacon and reporting its location to a database.

7. A trusted geolocation beacon, the beacon comprising:
a data bus communicatively coupled to a memory and other components of the system so that they may be managed by a controller;
a geolocation sensor;
a public key register storing beacon's public key;
a private key register storing beacon's private key;
wherein the controller is configured to execute the steps of the following method;
generating a public and private keys pair associated with the beacon;
associating a unique identifier with the beacon;
transmitting the public key associated with the unique identifier to an external device;
cyclically transmitting beacon's identifier as well as its transmitter's signal power;
transmitting a signal comprising unencrypted, variable data;
transmitting a signal comprising encrypted variable data, which are the same as the unencrypted variable data, the encryption being effected by using the private key associated with the beacon.

8. A trusted geolocation system, the system comprising:
at least one trusted geolocation beacon comprising;
a data bus communicatively coupled to a memory and other components of the system so that they may be managed by a controller;
a geolocation sensor;
a public key register storing beacon's public key;
a private key register storing beacon's private key;
wherein the controller is configured to execute the steps of the following method:
generating a public and private keys pair associated with the beacon;
associating a unique identifier with the beacon;
transmitting the public key associated with the unique identifier to an external device;
cyclically transmitting beacon's identifier as well as its transmitter's signal power;
transmitting a signal comprising unencrypted, variable data;
transmitting a signal comprising encrypted variable data, which are the same as the unencrypted variable data, the encryption being effected by using the private key associated with the beacon,
at least one client device configured to operate by:
obtaining the beacon's public key, from an external database, based on the beacon's identifier;
using this public key in order to decrypt the encrypted part of the received broadcast;
verifying whether the encrypted data and the unencrypted data match;
in case of a match, treating the beacon as a trusted beacon and determining a distance of the receiver from the beacon and reporting its location to a database;
a server comprising a database storing:
public keys of registered beacons together with the geolocations of the at least one trusted geolocation beacon; and
time instants at which a given client device changed location.
